(19) United States
(12) Patent Application Publication
(10) Pub. No.: US 2017/0063550 A1
(43) Pub. Date: Mar. 2, 2017

(54) Secure Digital Signature Apparatus and Methods

(71) Applicant: Keith J Brodie, Yorba Linda, CA (US)

(72) Inventor: Keith J Brodie, Yorba Linda, CA (US)

(21) Appl. No.: 14/695,032

(22) Filed: Apr. 23, 2015

(51) Int. Cl. H04L 9/32; H04L 29/06; G06F 21/35; H04L 9/08; G06F 21/32

(52) U.S. Cl. CPC H04L 9/3247; H04L 9/0869; G06F 21/32; G06F 21/35; H04L 63/126

(57) ABSTRACT

The invention is a secure digital signature device which generates digital signature key pairs using a hardware random number generator. It transmits public keys to one or more smart devices and signs bit strings at the request of smart devices without exposing private keys. Requests for signatures from smart devices are not fulfilled unless the user takes action on the apparatus of the present invention: pushing a button, swiping a fingerprint, scanning their eye. The requirement for user action precludes malware issuing unintended signatures through the smart device. The private keys are maintained solely on the apparatus of the invention and are therefore not vulnerable to attack by malware on the smart device or a host server.

### BACKGROUND OF THE INVENTION

Field of the Invention

The invention pertains to intelligent tokens with a cryptographic component. The invention also pertains to apparatus, systems and methods for digital signature algorithms. The invention also pertains to cryptographic key generation and management systems, in particular for public-key cryptographic systems.

Description of the Related Art

Federal Information Processing Standard 186-4 (FIPS 186-4) of July 2013 defines the Digital Signature Standard (DSS) and is hereby incorporated by reference in its entirety. The FIPS 186-4 glossary defines a digital signature as “The result of a cryptographic transformation of data that, when properly implemented, provides a mechanism for verifying origin authentication, data integrity and signatory non-repudiation.” Not all digital signatures are compliant with the DSS. FIPS 186-4 limits the set of cryptographic transformations for use in a DSS-compliant digital signature to the Digital Signature Algorithm (DSA), the RSA digital signature algorithm, and the Elliptic Curve Digital Signature Algorithm (ECDSA). The definition of a digital signature quoted above however, does not require a DSS-compliant cryptographic transformation. The term digital signature as used herein is as quoted from the FIPS 186-4 glossary above. A digital signature uses an asymmetric cryptographic system as its base. An asymmetric cryptographic system uses different keys to encrypt and decrypt a message.

FIPS 186-4 FIG. 1 on page 9 of shows generic digital signature processing. Note that the private key is an input to the signature generation process, and the public key is an input to the signature verification process. This depiction of digital signature processing shows hash processing applied to the message/data to produce a message digest, and the message digest as the input to both the signature generation and signature verification process. In some digital signature applications the message itself is used as the input to the signature generation and signature verification process. This is consistent with FIPS 186-4 FIG. 1 if one allows for a “hash function” that simply passes the message through. For the purposes of this specification digital signature generation and verification can be applied to raw both messages and message digests.

FIPS 186-4 defines the Digital Signature Algorithm (DSA), one of the alternative cryptographic transformations applicable to the Digital Signature Standard (DSS). This specification makes use of the phrase digital signature algorithm (without capitalization). The phrase digital signature algorithm as used herein does not refer only to the FIPS 186-4 DSA, but rather to any digital signature algorithm.

Digital signatures are used in many applications. Cryptocurrency transactions are made by applying a digital signature to a proposed transfer of currency units from one public key to another. Loan documents, stock purchase agreements, and other legally significant documents are signed with digital signatures.

A digital signature is made by a user with a smart device. For the purposes of this specification a smart device is a device with computational capability and a user interface; including but not limited to smartphones, tablets, phablets, laptops, notebooks, and computers of any form and size with and without data network connections.

Digital signatures have been forged. Malware operating on a smart device can capture the user's password for an application and allow for the private keys to be accessed without the user's consent. This can occur while the device remains in the user's possession. If the device is lost, the private keys are vulnerable to brute-force attack on the device's memory or attacking the device's operating system. Even when the private keys are not directly divulged, an adversary may force the application to apply digital signature to a fraudulent transaction or document.

In some digital signature applications the smart device generates the keys for digital signatures from an onboard random number generator. To the extent the onboard random number generator is not actually random; the resulting digital signature is vulnerable. The pseudo-random number generator used to generate digital signature keys in some smartphones has proven to be significantly non-random and vulnerable to analytical attack.

Some applications of digital signature algorithms operate through a smart device but do not rely on the smart device to generate or store private keys. These applications generally work with the smart device acting as a client to a server accessed over a data network. The client issues commands to the server to sign a document or sign a cryptocurrency transaction. Typically the user enters a password in the smart device to log the client onto the server. If the client smart device is lost or compromised with malware then the server logon password may be obtained by an adversary. Digital signatures applied with client-server systems have additional vulnerabilities; an insider in the organization managing the server can become an adversary who further compromises private keys and forge digital signatures. If the server's security is compromised, the user's digital signature is compromised.

The smart device, or the combination of smart device as client and a supporting server are both widely used for digital signature applications. The vulnerabilities identified above are limitations in the state of the art.

### BRIEF SUMMARY OF THE INVENTION

The invention is a secure digital signature device which generates digital signature key pairs. It transmits public keys to one or more smart devices and signs bit strings at the request of smart devices without exposing private keys. Bit string signature requests are physically confirmed by the user on the digital signature device to preclude the digital signature device from issuing unintended signatures due to illegitimate requests from a compromised or stolen smart device.

It is a purpose of the invention to enable the use of digital signatures without risking exposure of private keys in a smart device. It is another purpose of the invention to prevent the misuse of the digital signature processing capability to sign transactions or documents not intended by the user. It is a further purpose of the invention to ensure random number generation used in key generation is not compromised by the use of a vulnerable pseudo-random number generator. It is yet a further purpose of this invention to allow a user to safely keep private keys in their possession and therefore invulnerable to host server compromise.

This invention will be more fully understood in conjunction with the following detailed description and drawings.

### BRIEF DESCRIPTION OF THE SEVERAL VIEWS OF THE DRAWINGS

FIG. 1 is a functional block diagram of a first embodiment of the digital signature apparatus using a switch as the authorization element responsive to user action.

FIG. 2 is a drawing of the first embodiment of the digital signature apparatus in its enclosure shown in communication with a smart device.

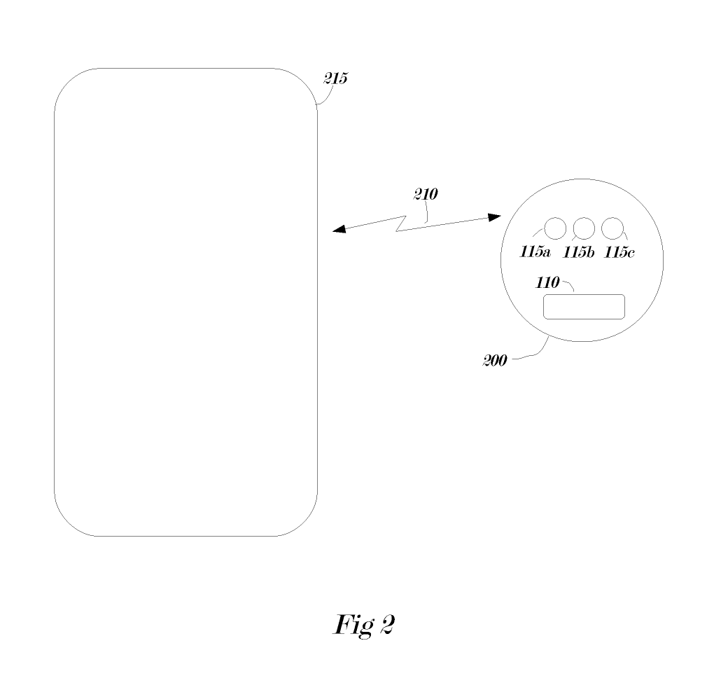

FIG. 3 is a functional block diagram of a second embodiment of the digital signature apparatus using a serial bus as the smart device communication element.

FIG. 4 is a drawing of the second embodiment of the digital signature apparatus in its enclosure.

FIG. 5 is a function block diagram of a third embodiment of the digital signature apparatus using a fingerprint scanner as the authorization element responsive to user action.

FIG. 6 is a drawing of the third embodiment of the digital signature apparatus in its enclosure shown in communication with a smart device.

FIG. 7 is a functional block diagram of a fourth embodiment of the digital signature apparatus using a camera as the authorization element responsive to user action.

FIG. 8 is a drawing of the fourth embodiment of the invention in its digital signature apparatus in its enclosure shown in communication with a smart device.

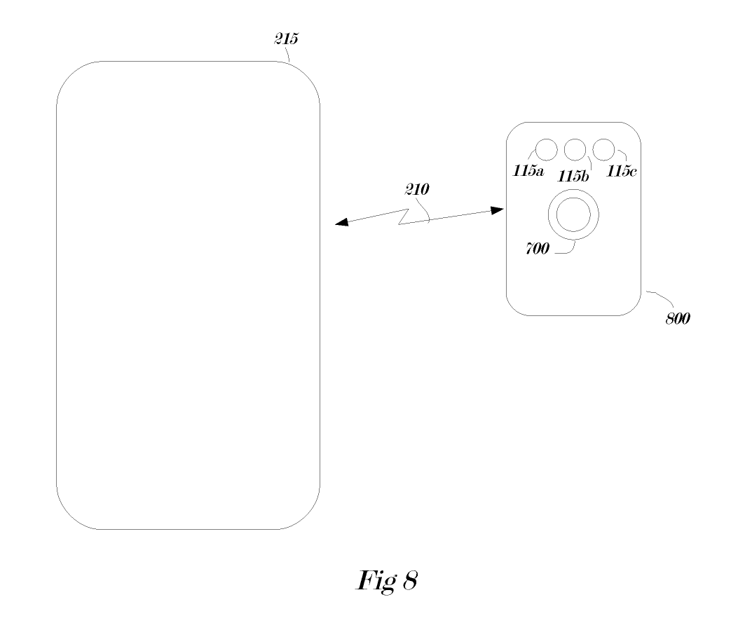

FIG. 9 is a flowchart for an embodiment of the operations of the digital signature apparatus in response to a digital signature request for embodiments using a switch as the authorization element responsive to user action.

FIG. 10 is a flowchart for an embodiment of the operations of the authorization sub-process for embodiments of the digital signature apparatus using a switch as the authorizing element responsive to user action.

FIG. 11 is a block diagram of an embodiment of the HRNG of the digital signature apparatus.

### DETAILED DESCRIPTION OF THE INVENTION

Throughout this detailed description there is a discussion of communication of messages and keys between a smart device and the digital signature apparatus. In the interest of readability, the word ‘device’ in this detailed description refers to a smart device, and the word ‘gadget’ in this detailed description refers to the digital signature apparatus of the invention. Using this convention, the sentence fragment “the message from the smart device to the digital signature apparatus” becomes “the message from the device to the gadget”.

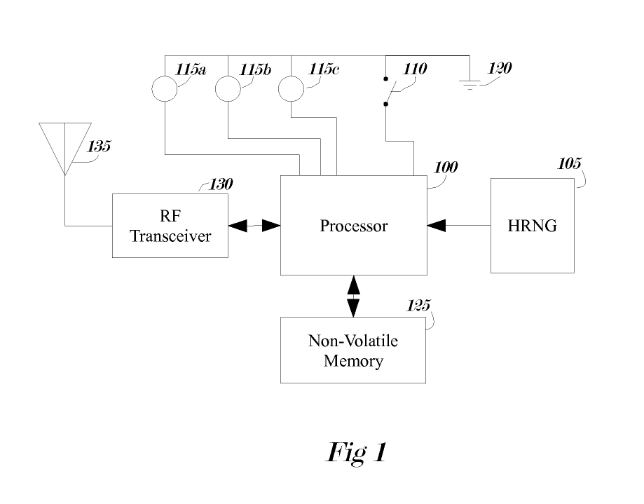

FIG. 1 is a functional block diagram of one embodiment of the gadget. The gadget communicates with a device through an RF link using antenna 135 and transceiver 130. Messages to and from the gadget are received and generated respectively in the processor 100. Among the functions of the processor is generating asymmetric key pairs. Key pairs are generated using random bit strings from the hardware random number generator 105. Key pairs are stored in non-volatile memory 125. A feature of the invention is the requirement for user action at the gadget to authorize some actions. In the embodiment of FIG. 1, signal lamp 115a is lit to indicate a digital signature is being requested by a device. The user authorizes a signature to be generated and sent to the device by momentarily closing switch 110 on the gadget. Registration of a new device with the gadget can be accomplished by sending a message from a previously registered device. Signal lamp 115b is lit to indicate a new device registration is pending. The user can authorizes a new device registration by momentarily closing switch 110 in response to signal lamp 115b. A registered device can request an encrypted copy of the stored key pairs in the gadget, a back-up of the keys in the gadget. The user authorizes an encrypted backup of key pairs stored in the gadget by momentarily closing switch 110 in response to signal lamp 115c.

The signal lamps, 115a, 115b, and 115c are preferably LED's, but may be any light emitting device. It is to be understood that when the lamp is lit it may be on continuously or flashing. It is also to be understood that the invention may use more or less than three lamps without departing from the meaning or spirit of the invention. For example, the functions of signal lamps 115a, 115b, and 115c could be combined into a single LED which has three colors, where the color is used to indicate which authorization is pending (signature request, new device registration, or key pair backup). It is also within the scope of the invention to have only one lamp and use it to indicate that some request is pending, leaving it to the user to determine which request is pending from the context of his or her interaction with the smart device.

Processor 100 of FIG. 1 is a computing element or elements. In some embodiments it is an embedded processor; in others it is two or more individual embedded processors which in total represent the function processor 100.

In this description of some of the embodiments of the invention; digital signatures are used for more than one purpose. The description distinguishes between digital signatures, public keys, and private keys for these uses. It is cumbersome to repeat the usage context for each appearance of the word ‘signature’ or ‘key’ in the sequel. Table 1 presents shortened phrases adopted to preclude repeated recitation of the context for each appearance of these words. These shortened phrases are adopted only in the interest of readability; they do not redefine “digital signature”, “public key”, or “private key”; nor do they alter or limit the reasonable interpretation of these phrases.

TABLE 1
Usage Distinction of Signatures and Keys

| Shortened Phrase | Full Context Phrase |
|---|---|
| Transaction Signature | A digital signature applied to a bit string by the gadget. The bit |
| | string is presented to the gadget by the device. The bit string |
| | signed with the transaction signature could represent any digital |
| | object in raw message or hashed message digest form, including |
| | but not limited to a cryptocurrency transfer and a document |
| | signature. |
| Transaction Private Key | A private key generated on the gadget and used by the gadget to |
| | generate a transaction signature. A gadget generates and stores a |
| | plurality of transaction private keys each with an associated |
| | transaction public key. |
| Transaction Public Key | A public key generated on the gadget and transmitted to the |
| | device, with which any party can verify the transaction signature. |
| | A gadget generates and stores a plurality of transaction public keys |
| | each with an associated transaction private key. |
| Device Signature | A digital signature applied by a device on a message to a gadget. |
| | This signature is generated using the device signing key, which the |
| | device receives from the gadget when the device is registered with |
| | the gadget. |
| Device Signing Key | A ‘private’ key generated in the gadget and passed to the device |
| | when the device is registered with the gadget. The key is intended |
| | to be kept private to the device, although it is not strictly private in |
| | the sense that it is known to the gadget that generated it. In some |
| | embodiments this key is used to sign messages from the device to |
| | the gadget. |
| Device Verification Key | A ‘public’ key generated in the gadget with a companion device |
| | signing key. It is a public key in the sense of FIPS 186-4 FIG. 1, |
| | namely that it is used as an input for message verification. The |
| | device verification key is however kept privately on the gadget. |
| Gadget Signature | A digital signature generated in the gadget using the gadget private |
| | key. |
| Gadget Public Key | A public key for verifying gadget signatures fixed and stored in |
| | the gadget at the factory. It is unique to the gadget. This key is |
| | used to verify that a message is from a particular gadget. |
| Gadget Private Key | A private key for generating gadget signatures fixed and stored in |
| | the gadget at the factory. It is never revealed by the gadget. |

The table has called out three use cases for digital signatures; specifically the transaction signature, the device signature, and the gadget signature. These three signature types do not necessarily share the same digital signature algorithm. Moreover it is within the scope of the invention for the transaction signature to make use of different signature algorithms for different key pairs. The digital signature algorithm for the transaction signature is defined when the transaction public and private keys are generated and employed by the gadget when a transaction signature using that pair is requested.

In all embodiments of the invention the gadget stores transaction key pairs it generates in non-volatile memory 125. In some embodiments the form of storage is a transaction key table comprising transaction key pairs, each pair comprising a transaction public key and a transaction private key.

In some embodiments the invention generates device key pairs, a device public key and a device private key. These may be stored in a registered device table in which a row comprises a unique device identifier, and the device key pair, each pair comprising the device signing key and device verification key. Only the device identifier and the device signing key are returned to the device, the device verification key is known only to the gadget. It is of note that the transmission of the signing key to the device is in contrast to the naming convention typical in the art. FIPS 186-4 FIG. 1 identifies the ‘private key’ as the key used in the signature generation. In the present invention the device signing key is not private to the gadget, it is generated on the gadget and transmitted to the device, where it is to be kept to sign messages intended for the gadget. In FIPS 186-4 FIG. 1 the key used in signature verification is the ‘public key’. For validating messages transmitted to the gadget, this ‘public’ key is the device verification key and it is kept private on the gadget.

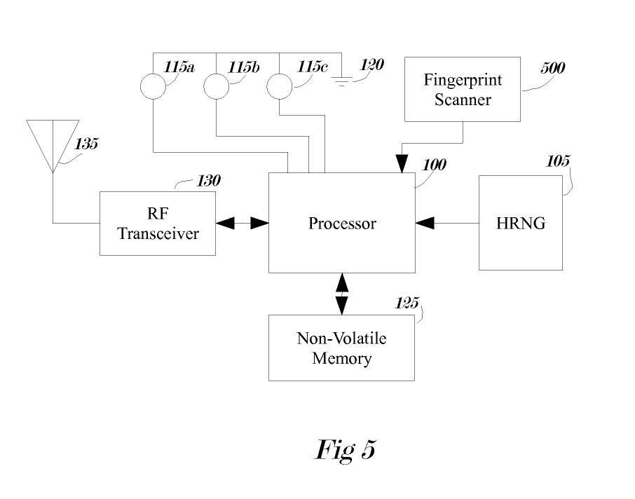

The use of the device signing key by the device and the device verification key in the gadget provides a layer of security that may seem unnecessary in light of the invention's use of user action to authorize transactions. This layer of security in the messaging protects the user's gadget from attack if the gadget is lost or stolen, but the registered device is still in the user's control. In the embodiment of FIG. 1 where the authorizing element comprises switch 110 this messaging layer is important because an attacker in possession of the gadget can order it to sign anything and authorize the signature with the push of a button. In the embodiment of FIG. 5 where the authorizing element comprises fingerprint scanner 500, this messaging layer is less critical. Even if the gadget of FIG. 5 is lost or stolen, the attacker cannot authorize use without physically attacking the gadget hardware or forging a fingerprint in some manner.

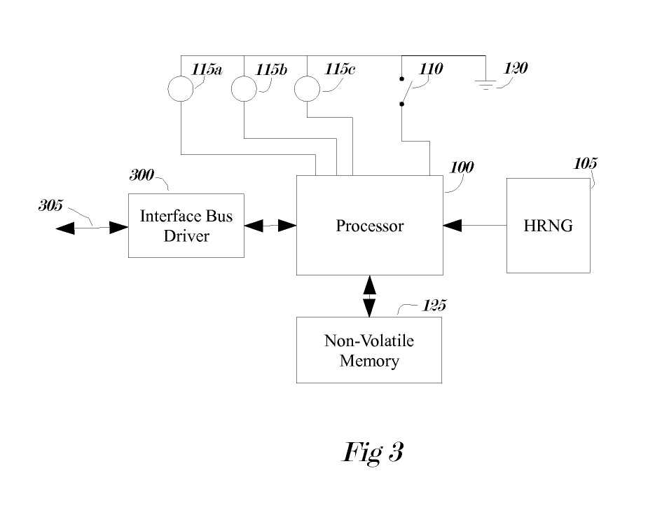

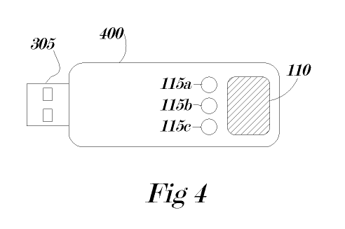

A functional block diagram of another embodiment of the invention is given in FIG. 3. In this embodiment communication between the device and the gadget takes place over an interface bus connector 305, whereas the embodiment of FIG. 1 used an RF link for communication between gadget and device. FIG. 4 is a drawing of one variant of this embodiment with a USB connector 305. Other variants include card-edge connectors, audio connectors, and any other signaling mechanism making use of conductors connecting the gadget and the device.

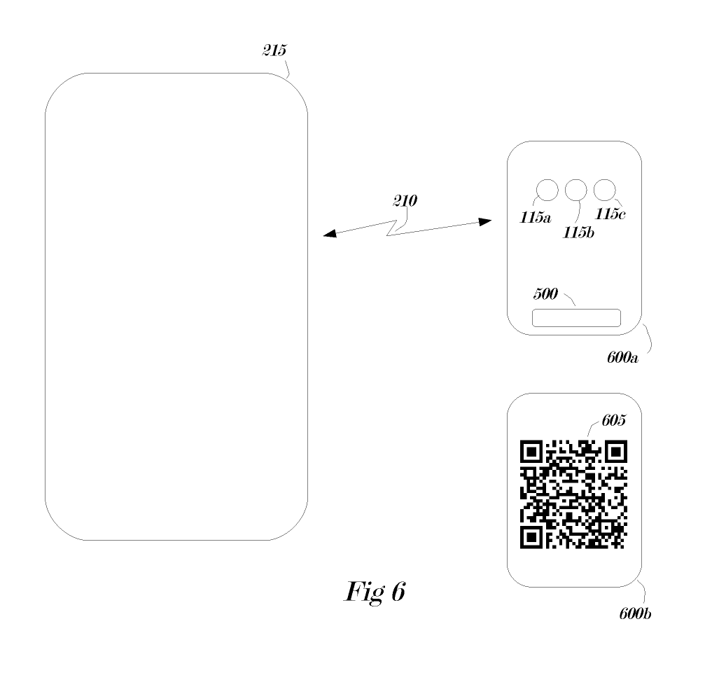

A functional block diagram of another embodiment of the invention is given in FIG. 5. This embodiment uses a recognized fingerprint scan to authorize a transaction signature, a new device registration, or a backup of transaction key pairs. FIG. 6 is a drawing of the same embodiment in its enclosure in communication with device 215 over RF link 210. A top-view of the gadget 600a shows a key-ring hole 205, signal lamps 115a, 115b and 115c, and the fingerprint scanner 500. The bottom-view of the gadget 600b shows the same key-ring hole 205, and a QR-code symbol 605 representing the gadget public key.

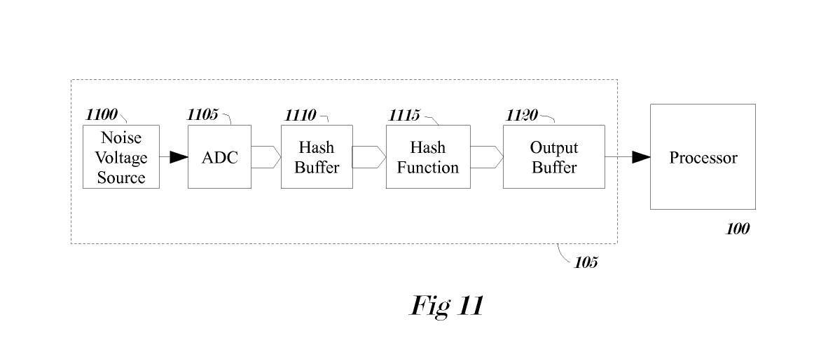

A hardware random number generator (HRNG) is shown as block 105 in FIG. 1. A HRNG utilizes an unpredictable physical process as a source of entropy. One embodiment of a HRNG is shown in FIG. 11. The entropy source is noise voltage generator 1100. One embodiment of the noise voltage generator is described in “A Broadband Random Noise Generator” by Jim Williams, published as Design Note 70 from Linear Technology Corporation. This generator amplifies the noise from a reverse-biased Zener diode to produce a one volt peak-to-peak output noise voltage. The output of the noise voltage generator is fed into an analog to digital convertor (ADC) 1105. The ADC samples the analog voltage and converts it to a bit string. This bit string is random, but not necessarily unbiased or without auto and cross-correlations. Bandwidth limitations, ADC irregularities and other factors may affect the statistical independence of the bits in the ADC output word. To ameliorate these potential weaknesses the output is buffered up in hash buffer 1110, processed through the hash function 1115, and output into another buffer 1120 from which it is output to the processor 100.

In order to ensure sufficient entropy in the output it is preferable that the input to the hash function stored up in buffer 1110 have more bits than the output of the hash function. A preferred embodiment of HRNG 105 accumulates 64 samples of an 8-bit output ADC 1105 in to a 512 bit message block in hash buffer 1110. This message block is processed in an SHA-256 hash function 1115 resulting in 32 bytes of output to buffer 1110. The SHA-256 algorithm is defined in the Secure Hash Standard, FIPS 180-4 Mar. 2012.

The invention is not restricted to a HRNG using Zener diode noise as an entropy source. Embodiments of the invention can make use of quantum vacuum fluctuations [T. Symul, S. M. Assad, and P. K. Lam, Real time demonstration of high bitrate quantum random number generation with coherent laser light, Applied Physics Letters, Vol. 98 Issue 23, 2011], avalanche photodiode dark count [S. K. Tawfeeq, A Random Number Generator Based on Single-Photon Avalanche Photodiode Dark Counts, Journal of Lightwave Technology, Vol. 27, No. 24, Dec. 15, 2009], thermal noise [Yu-Hua Wang, Huan-Guo Zhang, Zhi-Dong Shen, Kang-Shun Li, Thermal Noise Random Number Generator Based On SHA-2 (512), Proceedings of the Fourth International Conference on Machine Learning and Cybernetics, Guangzhou, 18-21 Aug. 2005], chaos [Oded Katz, Dan A. Ramon, and Israel A. Wagner, A Robust Random Number Generator Based on a Differential Current-Mode Chaos, IEEE Transactions On Very Large Scale Integration (VLSI) Systems, Vol. 16, No. 12, December 2008], or any other unpredictable physical process alone or in combination.

The procedural steps to generate public and private keys from the random bit string produced by the HRNG depend upon the particular digital signature method used. FIPS 186-4 contains a detailed description for the DSA, the ECDSA, and the RSA digital signature algorithm. These procedural steps are carried out in processor 100 with the necessary random bit strings from HRNG 105.

A fingerprint scanner 500 is shown in FIGS. 5 and 6. One embodiment of the fingerprint scanner comprises the FPS1080 Swipe Fingerprint Sensor from Fingerprint Cards AB. The sensor itself produces image data which must be compared with stored fingerprint images as is well known in the art. In some embodiments this comparison is carried out in processor 100. In others, it is carried out in a separate processor integral to the fingerprint scanner 500 block of FIG. 5.

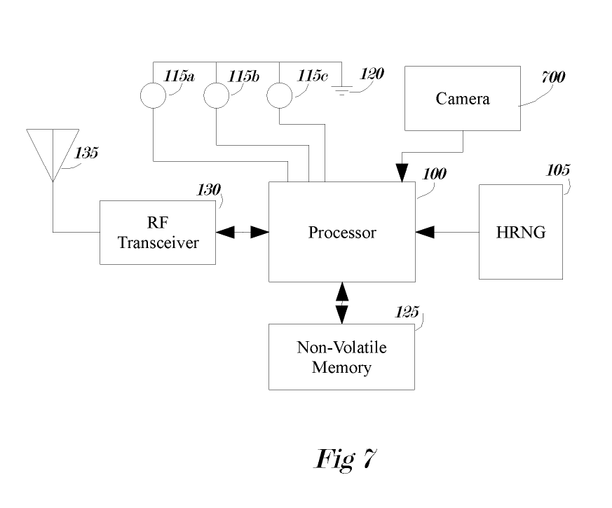

FIG. 7 is a functional block diagram of another embodiment of the gadget wherein a camera 700 is responsive to some biometric feature of the user and recognition of this feature is required to authorize a transaction signature. The camera can be visible or infra-red, and any biometric feature that can be captured with an image is within the scope of the embodiment, including but not limited to fingerprints, hand-geometry, palm print, the iris, the retina, and facial geometry.

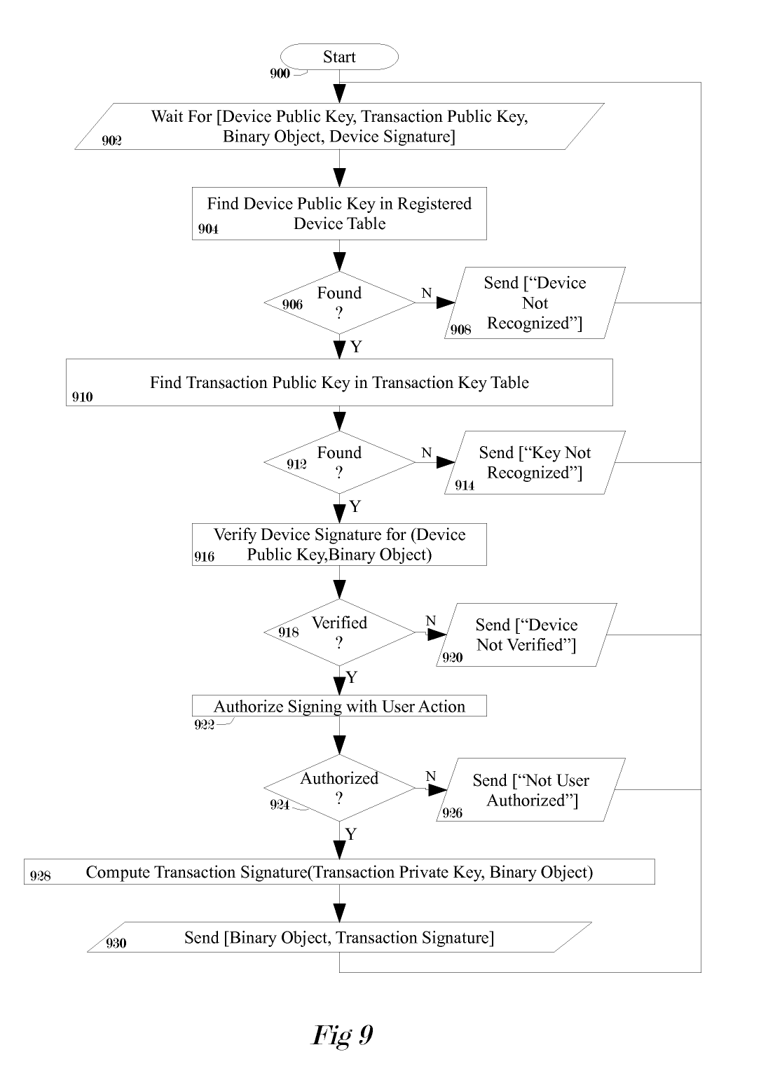

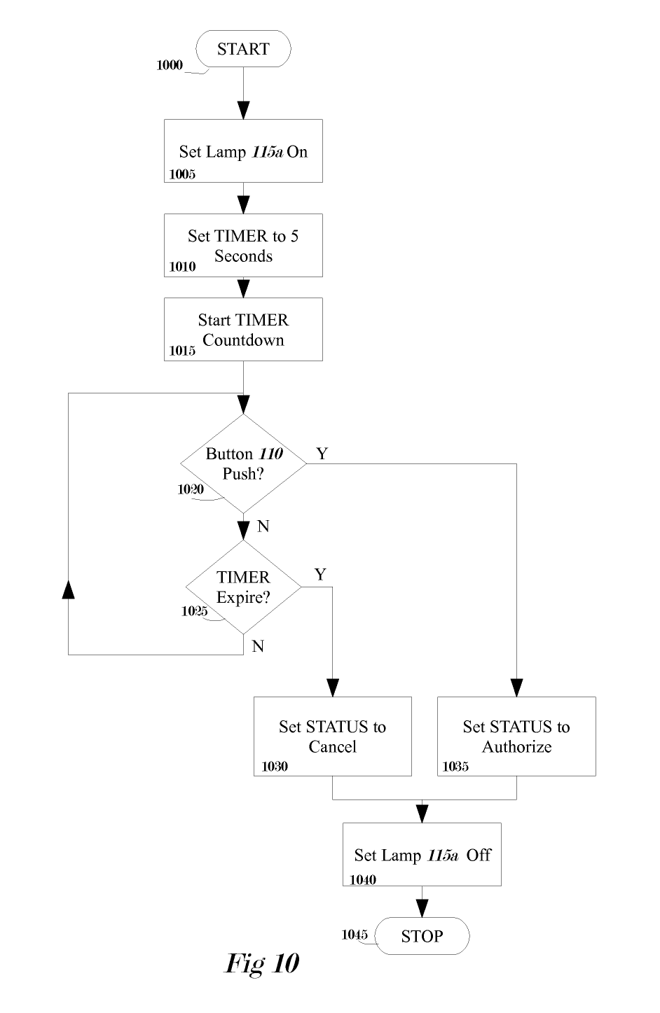

FIG. 9 is a flowchart for one embodiment of the processing steps to generate a transaction signature in the gadget. The process starts 900 and begins waiting for a transaction signature request message from the device 902. Once a request is received, the device public key is checked against the registered device table to see if the querying device is known to gadget 904. The outcome of this table search 906 determines whether the request is rejected 908 or the processing continues to determine if the requested public transaction key is known to the gadget 910. The result 912 of this table look-up is either a rejection 914 or continuing on to verify the signature applied to the transaction bit string with the device private key 916. The verification test result 918 causes the request to be rejected 920 or accepted for continued processing 922. Process 922 details depend on the embodiment; one embodiment of 922 for gadgets using a switch 110 is shown in FIG. 10. The authorization result test 924 results in a rejection of the request 926 or continuing on to compute the transaction signature on the transaction bit string 928. The transaction signature is send back from the gadget to the device in 928.

FIG. 10 is a flowchart for one embodiment of the processing steps to authorize an action in gadget embodiments using a switch 110, it is one embodiment of process step 922 from FIG. 9. Upon entry 1000 lamp 115a is lit 1005 to signal the user. A timer is set 1010 and started 1015 to countdown the time allowed for the user to respond. If button 110 is pushed 1020 while the timer has not expired 1024, the action is authorized 1035. If the timer expires without button 110 being pushed, the action is not authorized 1030. In either event, lamp 115a is extinguished 1040 and this sub-process stops 1045. In the processing embodiment of FIG. 9 control is returned to test 924.

Embodiments described above illustrate but do not limit the invention. Numerous modification and variations are possible in accordance with the principles of the present invention. Accordingly, the scope of the invention is defined only by the following claims.

I claim:

1. A secure digital signature device comprising:
a. a hardware random number generator;
b. a computing element which creates public and private keys utilizing the output of the hardware random number generator;
c. a non-volatile memory for storage of public and private keys;
d. a computing element which creates a digital signature for a bit string using one or more of the private keys,
e. a communication element for receiving bit strings from a smart device,
f. a communication element for transmitting digital signatures to a smart device, and
g. an authorization element having an authorized and unauthorized state wherein the digital signature of a bit string sent to the secure digital signature device is computed and sent to the smart device if and only if the authorization element is in an authorized state.

2. The secure digital signature apparatus of claim 1 wherein the authorizing element comprises a switch and the authorizing element is set to the authorized state for a limited period of time in response to switch action.

3. The secure digital signature apparatus of claim 1 wherein the authorizing element comprises a fingerprint scanner and the authorizing element is set to the authorized state for a limited period of time in response to the recognition of a known fingerprint.

4. The secure digital signature apparatus of claim 1 wherein the authorizing element comprises a camera and the authorizing element is set to the authorized state for a limited period of time in response to a recognition of one or more biometric elements where biometric elements include but are not limited to the iris, the retina, facial geometry, hand geometry, ear geometry, and the palm print.

5. The secure digital signature apparatus of claim 1 wherein the authorizing element comprises an RF transceiver and the authorizing element is set to the authorized state for a limited period of time in response to a recognized reply from an RF tag near the secure digital signature apparatus.

6. The secure digital signature apparatus of claim 1 wherein the authorizing element comprises a near-field transceiver and the authorizing element is set to the authorized state for a limited period of time in response to a recognized reply from a near-field tag.

7. The secure digital signature apparatus of claim 1 wherein at least one of the communication elements is a radio link.

8. The secure digital signature apparatus of claim 1 wherein at least one of the communication elements is an electrical data communication link.

9. The secure digital signature apparatus of claim 8 wherein the electrical data communication link is made through a memory card connector, a subscriber identity card connector, a smart card connector, a serial bus connector, or an audio connector.

10. The secure digital signature apparatus of claim 1 wherein at least one of the communication elements is a near-field communication link.

11. The secure digital signature apparatus of claim 1 additionally comprising a table of known smart devices.

12. The secure digital signature apparatus of claim 11 wherein entries in the table of known smart devices comprise a device public key for a known smart device.

13. The secure digital signature apparatus of claim 12 additionally comprising a computing element for digital signature verification.

14. The secure digital signature apparatus of claim 1 wherein the hardware random number generator entropy source comprises at least one of the fluctuation in current flowing through a semiconductor junction, the fluctuation in voltage across a semiconductor junction, the fluctuation in period between radioactive decay events, and the fluctuation of voltage in a resistance.

15. A method for generating a digital signature for a bit string in a secure digital signature apparatus comprising the steps of:
a. receiving a message comprising the bit string from a smart device;
b. computing a digital signature for the bit string using a private key stored in non-volatile memory in the digital signature device; and
c. sending a message comprising the digital signature to the smart device
wherein the digital signature is computed and sent to the smart device only if authorized by user action.

16. The method of claim 15 wherein the user action comprises at least one of activating a switch, scanning a fingerprint, and aligning one or more biometric elements with a camera wherein biometric elements include but are not limited to the iris, the retina, facial geometry, hand geometry, ear geometry, and the palm print.

17. The method of claim 15 additionally comprising the step of verifying that the bit string has been sent by a known smart device prior to computing the digital signature and sending it to the smart device.

18. The method of claim 17 wherein the step of verifying that the bit string have been sent by a known smart device is carried out by verifying a preliminary digital signature received from the smart device at substantially the same time as the bit string with a device public key.

19. A method for adding an entry to a smart device table in a secure digital signature apparatus comprising the steps of:
a. receiving a message comprising a device public key, and
b. storing the device public key in the smart device table only if authorized by user action.

20. The method of claim 19 wherein the user action comprises at least one of activating a switch, scanning a fingerprint, and aligning one or more biometric elements with a camera wherein biometric elements include but are not limited to the iris, the retina, facial geometry, hand geometry, ear geometry, and the palm print.
